(19) United States
(12) Patent Application Publication
(10) Pub. No.: US 2002/0126051 A1
(43) Pub. Date: Sep. 12, 2002

(54) Multi-purpose, ultra-wideband antenna

(76) Inventor: Asu Ram Jha, Cerritos, CA (US)

Correspondence Address: JHA TECHNICAL CONSULTING SERVICES, 12354 Charlwood Street, Cerritos, CA, 90703, US

(21) Appl. No.: 10/061,062

(22) Filed: Jan. 18, 2002

Related U.S. Application Data
(63) Continuation-in-part of application No. 09/709,764, filed on Nov. 9, 2000, now abandoned.

(51) Int. Cl. H01Q 1/24; H01Q 1/48

(52) U.S. Cl. 343/702; 343/846

(57) ABSTRACT

The multi-purpose, ultra-broadband antenna structure is comprised of a radiating element, a conducting ground plate, a feed line, a grounded mini-tab section and a radio frequency input connector. The grounded mini-tab section represents a unique concept and is quite different from other techniques to provide broadband capability. The antenna structure does not use any dielectric substrate or bonding agent or discrete impedance matching circuit or tuning mechanism, thereby providing a low-cost, compact, low-profile and rugged antenna design capable of operating over ultra-wideband under severe operating environments. This antenna can operate under harsh mechanical and thermal environments with no degradation in reliability or performance or structural integrity. The antenna permits easy integration of frequency hopping and direct-sequence spread spectrum techniques to provide immunity against co-channel interference, multipath reflections, signal fading, and electronic jamming. Different versions of this antenna have been fabricated and tested. The tests demonstrated high gain and radiation efficiency over a wideband in UHF-, L-, and S-bands. This antenna structure is best suited for commercial, military and space applications, where secured communication, high data transmission rates, good quality video signals, high structural integrity, and extremely high reliability are the principal requirements under severe operating environments. Other potential applications include target-locating systems, Global Systems for Mobile (GSM) Communications, Advanced Mobile Phones (AMPs), Personal Communication Systems (PCSs) and new generations of communication systems including 3G and 4G systems.

### RELATED U.S. APPLICATION DATA

### Int. Cl: HO1Q001/38, HO1Q1/48

### U.S. Cl: 343/795, 3431848, 343/752

### Field of Search: U.S. Pat. Nos. 4,700,194; 6,281,843; 4,835,538; 6,040,803

### REFERENCES CITED

U.S. Patent Documents:

(1) U.S. Pat. Nos. 5,507,012; 5,777,586 Filed by RangeStar Wireless, Inc., San Jose (Calif.), “2.4 GHz Vertically Polarized, Embedded Omni-directional Antenna”.

(2) U.S. Pat. No. 6,281,843 Filed by Sam Sung Electronics CO, Ltd. (Suwon) Korea, “Planar Broadband Dipole Antenna for Linearly Polarized Waves”.

(3) U.S. Pat. No. 4,700,194 Filed by Matsushita Electronic Industrial Co, Ltd, Osaka (Japan) on behalf of the inventor(s) Ogawa et al, “Small Antenna”.

Title of Invention: Multipurpose, Ultra-wideband Antenna

### CROSS-REFERENCES TO RELATED APPLICATION

(1) K. D. Katsibas et al,“Folded Loop Antenna for Mobile Handheld Unit”, IEEE Trans. On Antennas and Propagation, Vol46, February 1998, pp. 260-266.

(2) Tokio Taga et al, “Performance Analysis of a Built-in Planar Inverted-F Antenna for 800-MHz Band Portable Radio Units,” IEEE Journal on Selected Areas in Communication, No. 5, June 1987, pp.921-925.

(3) J. T. Rowley et al, “Performance of a Shorted Microstrip Patch Antenna,” IEEE Trans. On Antennas and Propagation, vol. 47, May 1999, pp.815.

(4) Rebeckka Porath, “Theory of Miniaturized Shorting-Post Microstrip Antennas,” IEEE Trans. On Antennas and Propagation, Vol.48, January 2000, pp.41-46.

(5) Y.Hwang et al, “Planar Inverted-F Antenna Loaded with High Permittivity Material,” Electron Letter, Vol. 31, September 1995, pp. 1710-1712.

### BACKGROUND OF THE INVENTION

1. Field of Invention

The present invention relates to low-cost, multi-purpose, ultra-wideband planar antenna. This antenna is capable of transmitting and receiving linearly polarized waves over a very wide frequency spectrum. This low profile, light weight antenna structure has a built-in provision for integration of frequency hopping and direct-sequence spread spectrum techniques to provide immunity against multipath reflections, cross-talk between channels, and electronic jamming signals.

2. Description of the Related Art

Various planar and microstrip antennas are depicted by: U.S, Pat. No. 5,847,682 to Shyr-Yeong Ke entitled “Top Loaded Triangular Printed Antenna” which described a loaded triangular printed circuit antenna. This Antenna reveals a planar antenna structure capable of providing wideband capability and high radiation efficiency. The antenna structure comprises a triangular shaped radiating element, a pair of grounded strips, a microstrip input transmission line section, a grounded surface, and a dielectric substrate. This antenna structure is complex and will require expensive fabrication process.

U.S. Pat. No. 4,700,194 to Ogawa et al entitled “Small Antenna” which describes a complex antenna structure consisting of a radiating element, ground plate, a polytetrafluoroethylene substrate reinforced with glass fiber cloth having a dielectric constant of 2.6, a grounded section of the radiating element, and a 50-ohm RF input connector. This antenna offers low-profile, moderate gain, and a nearly omni-directional radiation pattern most ideal for paging systems and cordless telephones operating at 930 MHz frequency only. The antenna patent by Owaga et al is specifically designed for portable radio application only and, thus, making it less attractive for other applications. Furthermore, this antenna structure employs a dielectric substrate that will make the antenna fabrication more complex, costly, and susceptible to surface wave losses.

U.S. Pat. No. 4,835,538 to McKenna et al entitled “Inverted Stacked Array Antenna” which describes an antenna structure comprising of three radiating elements and three different substrate layers. High design complexity and excessive fabrication cost are its major disadvantages. In addition, McKennan antenna requires optimum selection of substrate thickness and spacing to meet broadband requirements, which will further increase the design complexity and fabrication cost.

U.S. Pat. No. 6,040,803 to Spall describes an antenna structure specifically designed for radiotelephones operating over limited frequency spectrum from 810 to 885 MHz only. The antenna structure is comprised of two radiating elements attached to opposite sides of a dielectric substrate of high permittivity, a ground plate, and a 50-ohm input RF connector.

U.S. Pat. No. 6,281,843 Guennadi et al entitled “Planar Broadband Dipole Antenna for Linearly Polarized Waves” which describes an antenna structure comprising of a radiation plate over a conducting ground plate, and a ground plate. Printed patterns are formed on both sides of the radiation plate and a dielectric substrate is used between the grounded conducting plate and the radiation plate. Each of the upper and lower surfaces of the radiation plate involves a dipole element for radiating waves and a feed line for feeding the radio frequency signals. A matching element is connected to a line-balance converter known as BALUN to provide impedance match. This antenna structure demonstrated a VSWR of 2:1 and small RF losses over a wide frequency spectrum in the UHF-band only.

Most of the microstrip planar antenna structures mentioned under “Cross-Reference to Related Applications” have limited applications and lower peak gain and operate mostly in the UHF- and L-bands. These antennas use either single layer thick dielectric substrate or multi-layer substrate technique to achieve an instantaneous bandwidth close to 15% in UHF-band or L-band regions. However, use of a thick substrate causes several problems such as excitation of severe surface waves, high radiation losses in the feed network, excessive weight, increased design complexity, high fabrication cost, and wide separation between the radiating element and the ground plate. In case of antennas using multi-layer dielectric substrates, both the design complexity and fabrication cost will increase significantly. Furthermore, slight difference in the relative dielectric constant and layer thickness from one substrate layer to another substrate layer will introduce higher radiation, scattering, and surface wave losses which will result in distortion in far field antenna radiation patterns.

### BRIEF SUMMARY OF THE INVENTION

The primary objective of the present invention is to develop a low-cost, low-profile, reliable and robust antenna structure capable of transmitting and receiving linearly polarized RF signals over a wide bandwidth in multiple frequency bands. The secondary objective is to design the antenna for multiple functions and applications such as secured communication, high data transmission rates, and multiple receive/transmit capability for voice and video channels under severe multipath reflections, electronic jamming, and signal fading environments, generally encountered in military and space applications.

The multi-purpose, ultra-wideband antenna described in this patent application provides effective solutions to the problems cited in various U.S. Patent Documents and Cross-References mentioned herein. Performance related problems associated with other antennas include low peak gain and poor radiation efficiency over wide bandwidth in various frequency bands, excessive fabrication costs, high feed losses, and surface wave losses in case of thick substrates or multi-layer substrate configurations.

The antenna structure described in this patent application have several advantages including low production cost, robust design, high gain and radiation efficiency over wide frequency spectrum in UHF-, L- and S-bands, easy integration of frequency hopping and direct-sequence spread spectrum techniques to reject electronic jamming and multipath signals, and reliable RF performance under severe operating environments. The antenna structure described in this patent application is best suited for industrial, military and space applications, where reliable operation under harsh operating environments is the principal requirement.

The antenna structure described herein uses no bonding agent or dielectric substrate or tuning mechanism, thereby minimizing design complexity, feed radiation losses, and surface wave related problems. The antenna described in this patent application requires only four discrete elements, namely, a radiating element or radiation plate of which minitab section is an integral part, a conducting ground plate, a feed line, and a 50-ohm RF connector. The radiation plate height above the ground plate is very small, thereby providing a low-profile feature which is considered most attractive for many military and space applications. The mini-tab section is soldered to the ground plate. One end of the feed line is soldered to the radiating element or plate, while the other end is soldered to the center pin of the input RF connector. Robust construction, compact packaging, and low-profile features offer the most reliable antenna capable of operating under severe thermal, mechanical, electronic jamming and multipath environments.

### BRIEF DESCRIPTION OF THE SEVERAL VIEWS OF THE DRAWINGS

FIG. 1 is a perspective view of an embodiment of the multi-purpose, ultra-broadband linearly polarized antenna. FIG. 1 shows the critical elements of the antenna.

FIG. 2 shows a perspective view of the radiating element or plate and the mini-tab section, which is an integral part of the radiating element.

FIG. 3 is a plan view of the embodiment of FIG. 1.

FIG. 4 shows a cross-sectional view of the embodiment of FIG. 1.

FIG. 5 is a bottom view of the embodiment of FIG. 1.

FIG. 6 shows a measured radiation pattern of the embodiment of FIG. 1 at a selected test frequency of 2425 MHz.

FIG. 7 shows the measured 2:1 Voltage Standing Wave Ratio (VSWR) over a bandwidth of 15% and at a center frequency of 2425 MHz.

### DETAILED DESCRIPTION OF THE INVENTION

The present invention relates to a multi-purpose, ultra-wideband, antenna capable of transmitting and receiving linearly polarized electromagnetic (EM) waves over a wide frequency spectrum. The antenna structure uses no dielectric substrate or bonding agent or impedance matching circuit or tuning element. The antenna comprises of four major elements, namely, radiating element incorporating a mini-tab section grounded to the ground plate, a conducting ground plate, a feed line with one end rigidly soldered to radiating plate and the other to the center conductor pin of the RF connector, and a 50-ohms RF input connector. The antenna structure possesses several advantages such as compact size, low-profile, low-cost, rugged construction, small weight, and maximum gain and radiation efficiency over a wide bandwidth. Furthermore, the present invention provides natural integration of frequency hopping and direct-sequence spread spectrum techniques to achieve secure communication, high data transmission rates, and multiple video/voice channel capability under severe multipath and electronic jamming environments. Its robust construction and outstanding RF performance over wide band makes it most attractive for battlefield, military and space applications, where reliable RF operation under harsh operating environments is the principal requirement.

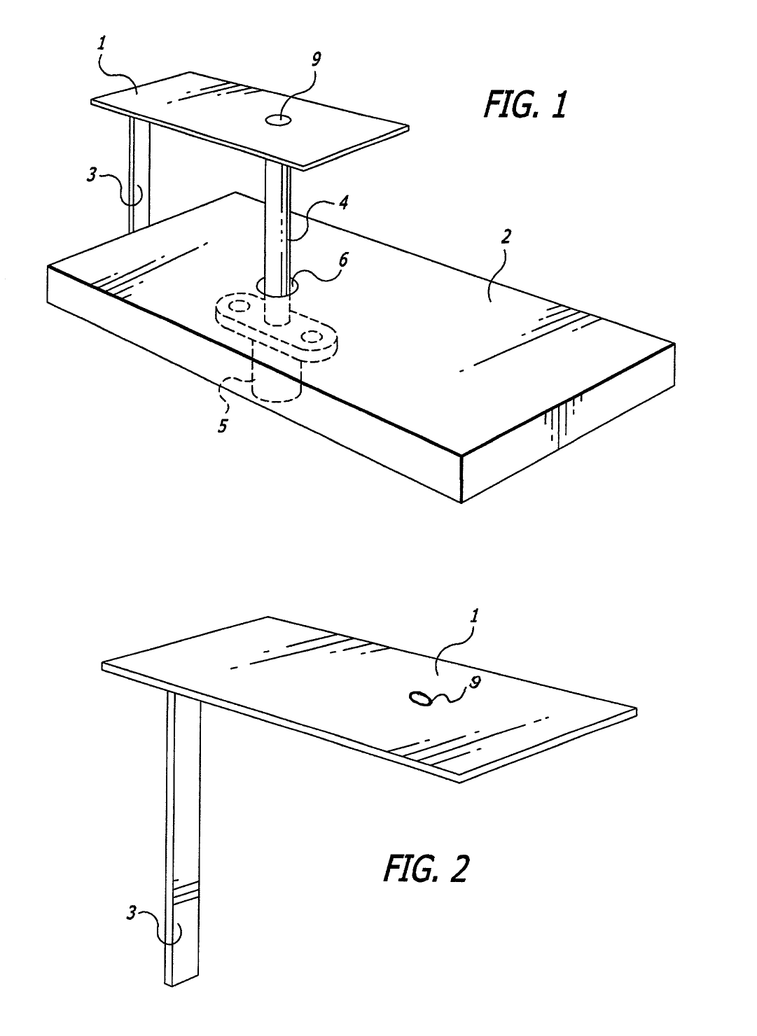

FIG. 1 shows the perspective view of the multi-purpose, ultra-wideband antenna of the present invention. The perspective view shown in FIG. 1 clearly identifies the radiating element 1, the mini-tab section an integral part of the radiating element 3, the conducting ground plate 2, the feed line 4 soldered to the radiating element 1 and the center pin of the RF connector 5. The conducting ground plate 2 can be made from a metal with reasonable thickness capable of providing required rigidity.

FIG. 2 is a perspective view of the radiating element 1 and the mini-tab section 3 an integral part of the radiating element. Both are made from a good conducting thin metallic sheet. The width of the mini-tab section 3 grounded to the ground plate 2 varies from 20 to 35% of the radiating element 1 width depending on bandwidth requirement. One end of the feed line is soldered to an optimum location 9 on the radiating element 1.

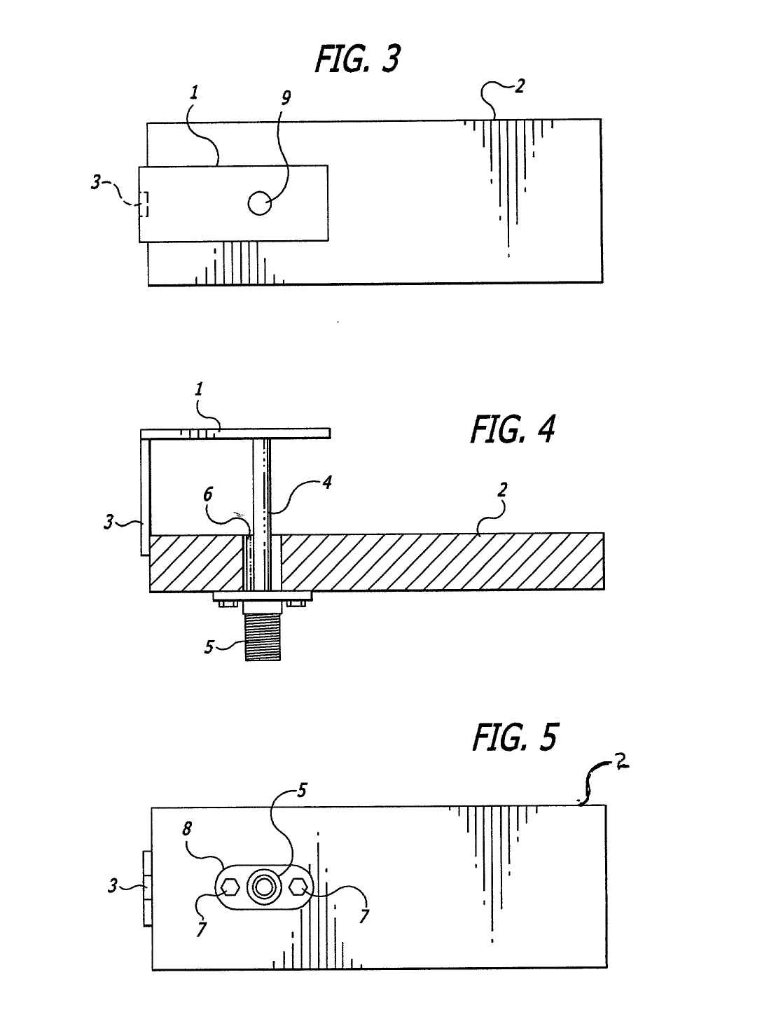

FIG. 3 is the plan view of the embodiment of FIG. 1. The plan view shows the radiating element 1 made from conducting thin metallic sheet, optimum soldered location 9 of the feed line 4 on the radiating element 1, and the mini-tab section 3 soldered to the conducting ground plate 2. The other end of the feed line 4 is soldered to the center pin of the RF connector 5 (not shown here). Experimental investigation indicates that the length and width of the conducting ground plate 2 must be greater than three times the length and width of the radiating element 1, if optimum RF performance over wideband is desired. Good impedance match over wideband is dependent on the height of the radiating element 1 over the ground plate 2, dimensions of the ground plate 2, and the soldered location 9 of the feed line 4 (not shown here) from the mini-tab section 3. Based on the above statements, a VSWR of 2:1 has been achieved over wide frequency spectrum in UHF-, L-, and S-hands.

FIG. 4 is a cross-sectional view of the embodiment of FIG. 1. FIG. 4 shows all the critical elements of the antenna. These elements include a radiating plate 1 over the ground plate 2, a mini-tab section 3 an integral part of the radiating element 1, a feed line 4 soldered to the radiating element 1 and pin of the RF connector 5. The feed line 4 can be made either from copper or brass round rod with diameter close to one-tenth of an inch. It is important that the diameter ratio of air gap 6 to feed line 4 must be 2.303 to maintain 50 ohms in the air gap shown in the conducting ground plate 2.

FIG. 5 shows the bottom view of the embodiment of FIG. 1. FIG. 5 indicates the location of the RF connector 5 on the ground plate 2, connecter flange 8, securing screw 7, and soldered location of the mini-tab section 3 to the ground plate 2. The screw 7 secures the connector flange 8 to the ground plate 2 to provide high mechanical integrity under severe operating environments.

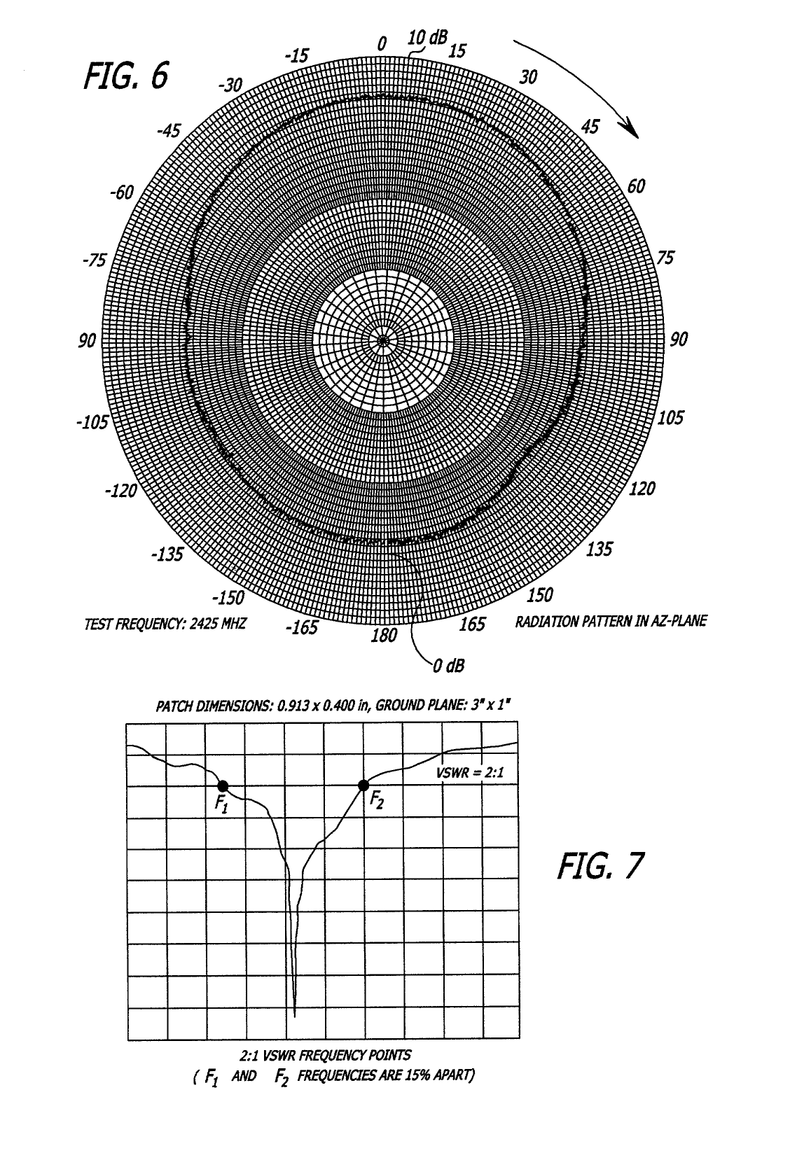

FIG.6 shows the far field radiation pattern of the embodiment of FIG. 1 measured at a center frequency of 2425 MHz. Such radiation patterns have been obtained (not shown here) over a wideband at different center frequencies. The laboratory tests revealed a peak antenna gain greater than 4.5 dB and radiation efficiency exceeding 95% over the entire frequency bandwidth in S-band.

FIG. 7 shows the 2:1 VSWR of the embodiment of FIG. 1 measured at a center frequency of 2425 MHZ and over a bandwidth exceeding 15%. No tuning mechanism or discrete impedance matching element is deployed to achieve the RF performance over wideband in different frequency bands, namely, UHF-, L-, and S-bands.

The present invention is best suited for industrial military, and space applications where reliable RF operation and high structural integrity are the principal requirements. The multi-purpose, ultra-broadband has potential commercial applications including third generation (3G) and fourth generation (4G) communications systems capable of incorporating wideband-CDMA technology and complex modulation techniques to achieve high data rates, and secured or covert communication under electronic jamming environments. In addition, this antenna structure is most suited for deployment in wave division-multiplexing (WDM) and dense-WDM telecommunications systems, target locating devices, battlefield communications systems, Global Systems for Mobile (GSM) communications systems, satellite communication equipment, and host of other systems.

### Design Equation for the Multi-purpose, Ultra-wideband Antenna

The resonant frequency Fₒ of this antenna configuration can be computed using the following equation:

Fₒ=[v/K(L+W)]

Where, v is the velocity of the light (3×10¹⁰)cm/sec, L and W are the length and width of the radiating element, respectively, in cm. , and K is the design parameter whose value varies between 3 and 4 depending on the operating frequency. The length (L) of the radiating element varies between 0.13 λ₀ to 0.14 λ₀, where λ₀ is the wavelength at the resonant frequency. The width (W) of the radiating element is slightly less than 0.1 λ₀. The thickness of radiation element or plate incorporating the mini-tab section can be as small as 1/32 of an inch capable providing the required rigidity. As a general rule of thumb, the ground plate length and width are roughly three times the length and width of the radiating element. The height of the radiating element 1 above the ground plate 2 varies between 2 to 3% of the resonance wavelength (λ₀), depending on the resonance frequency and bandwidth requirements. Sometimes it may require slight adjustments in these dimensional parameters to optimize overall antenna performance.

What is claimed:

1. The present invention is related to a multi-purpose, ultra-wideband antenna comprising of a conducting radiating element placed over a conducting ground plate, a feed line for feeding RF signals to the said radiating element, a 50-ohm RF input connector, and a mini-tab section an integral part of the radiating element but grounded to ground plate.

2. The antenna claimed in claim 1 uses no dielectric substrate or tuning mechanism or impedance matching circuit and represents a simple, rugged, low-profile, low cost antenna structure capable of operating under severe environments with no compromise in reliability or performance.

3. The low-profile multi-purpose, ultra-wideband antenna claimed in claim 1 provides the RF radiated energy in both the Azimuth (AZ) and Elevation (EL) planes through its radiating element located above the conducting ground plate.

4. The multi-purpose, ultra-wideband antenna as claimed in claim 1, wherein the antenna structure comprises:
(a) A feed line for feeding the radio frequency (RF) signals to the radiating element.
(b) A feed line connects the RF input connector located in the ground plate and to the radiating element through soldering process.

5. The antenna structure as claimed in claim 1, wherein no dielectric substrate or bonding agent is used, except air gap between radiating element and ground plate.

6. The multi-purpose, ultra-wideband antenna as claimed in claim 4, wherein the feed line can be made from a copper or brass rod.

7. The antenna structure as claimed in claim 4, wherein the feed line can be from a circular rod or thick wire.

8. The multi-purpose, ultra-wideband antenna as claimed in claim 1 comprising: A conducting ground plate; a rectangular radiating element for radiating Rf waves; the said radiating element over the conducting plate; a feed line for feeding RF signals to the said radiating element; and air medium between the conducting ground plate and the radiating element, and a 50-ohm Rf connector.

9. The antenna as claimed in claim 8, wherein the upper suffice of the radiating element or plate radiates maximum energy into nearby space.

10. The multi-purpose, ultra-wideband antenna as claimed in claim 8, wherein the RF feeder comprises of a conducting line for feeding the RF signals to the radiating plate.

11. The multi-purpose, ultra-wideband antenna as claimed in claim 8, wherein the air between the radiating element and the conducting ground plane constitutes the dielectric medium with relative dielectric constant of unity.

12. The antenna structure as claimed in claim 8, wherein the radiating element can be made from a brass sheet with thickness equal to or greater than 1/32 inch.

13. The multi-purpose, ultra-wideband antenna as claimed in claim 8, wherein the feed line can be made from a copper or brass rod with diameter close to 1/10 inch.

14. The multi-purpose, ultra-broadband antenna as claimed in claim 8, wherein the conducting ground plate can be made from standard aluminum metal of thickness between 1/8 and 1/10 of an inch to reduce fabrication cost.

15. The multi-purpose, ultra-broadband antenna as claimed in claim 1, wherein offers radiation efficiency greater than 95% and peak antenna gain exceeding 4.5 dB over a wide frequency spectrum in different frequency bands.

16. The multi-purpose, ultra-wideband antenna structure offers a low-cost, low-profile antenna that have potential applications in commercial, military and space systems.
